(19) United States
(12) Patent Application Publication
(10) Pub. No.: US 2011/0043335 A1
(43) Pub. Date: Feb. 24, 2011

(54) METHOD FOR THE OPERATION OF A TRANSPONDER FOR THE RADIO FREQUENCY IDENTIFICATION (RFID) AND RFID TRANSPONDER

(75) Inventors: Karl-Heinz Feierle, Dornbirn (AT); Gerhard Schedler, Mauren (LI); Reinhold Gantner, Bludenz (AT)

Correspondence Address: BAKER & DANIELS LLP;111 E. WAYNE STREET, SUITE 800, FORT WAYNE, IN, 46802, US

(73) Assignee: IDENTEC SOLUTIONS AG, Lustenau (AT)

(21) Appl. No.: 12/855,774

(22) Filed: Aug. 13, 2010

(30) Foreign Application Priority Data
Aug. 13, 2009 (DE) 10 2009 037 475.2

(51) Int. Cl. H04Q 5/22

(52) U.S. Cl. 340/10.1

(57) ABSTRACT

The invention relates to a method for the operation of an RFID transponder, which is characterized by the fact that the RFID transponder is operated either in broadcast mode or in bidirectional response mode or simultaneously in both aforementioned modes. The RFID transporter is equipped with a wireless transmitter as well as with a wireless transmission/reception unit for operation in these two modes, said wireless transmitter and wireless transmission/reception unit being operable independently from one another.

The invention relates to a method for the operation of a transponder for radio frequency identification (RFID) and RFID transponder.

Classic, so-called beacon transponders which work in broadcast mode are well-known. The transponder possesses a storage medium upon which static data are stored. The data on the storage medium are continuously transmitted by the transponder or are sent at a programmable interval (ping rate) in the broadcast method. This operation takes place completely automatically. The transponder transmits by itself, without having to be alerted by a read/write device. It does not possess a receiver and therefore cannot be actively addressed. In the case of this beacon transmission method only a unidirectional communication exists from the transponder to a receiving unit. There can be several transponders in the environment. If all transponders were to send simultaneously, it would lead to a great data collision rate. In order to prevent data collisions here, by way of a jitter operation the transmission of the data of the individual transponders is not triggered at a fixed starting point, but rather this starting point varies in the case of each transponder within a certain frame under the principle of contingency.

A beacon transponder has the advantage that it simply transmits its information plus additional data (short string) in many rapidly running applications, said data can be acquired with high security and the battery life can be precisely calculated.

In contrast to this a so-called response transponder works in bi-directional operation. The transponder possesses its own receiver, with however; on a different frequency, wherein the broadcast operation is maintained.

The RFID transponder can also be operated in so-called wakeup mode, wherein upon the receipt of a wakeup command from a higher level transmission/reception unit either broad cast mode or respond mode or both modes are activated.

Through operation in broadcast mode or in response mode or in both modes applications can be generated which are based on several thousand transponders, which all work in broadcast mode and transmit their identification codes and if applicable additional data within a limited geometric area. Additional data can then be purposefully requested and read out in response mode by selected transponders or these transponders can be written with further data. Therefore new possibilities arise for rapid applications, which with a high battery life also make it possible to realize read/write cycles.

The inventive RFID transponder itself comprises in known manner a processor, data storage in the form of a read only memory fixed memory and/or a rewriteable memory as well as a wireless transmission device. In accordance with the invention an additional transmission/reception unit is provided which can be operated independently from the initially named transmission device. As a result the RFID transponder can be operated simultaneously in two different operating modes, namely in broadcast mode, in which the wireless transmission device is active and in bidirectional response mode, in which the wireless transmission/reception unit is active.

The RFID transponder comprises an antenna, which can be used as a common antenna for the wireless transmission device and the wireless transmission/reception unit.

Two separate antennas can also be provided for the wireless transmission device and the wireless transmission/reception unit.

In addition the transponder can contain interfaces for communication with the environment, for example one or more sensors for acquisition of environmental data as well as one or more actuators as output interfaces to the environment or a user.

It is important that the two operating modes, in particular broadcast mode as well as response mode are not switched, but rather exist simultaneously.

Different transmission frequencies and possibly transmission rates are used for broadcast mode and response mode, as well as for wakeup mode. This ensures that broadcast mode does not disturb transmission in bidirectional response mode and vice versa.

As a result of this an advantageous usage of the permitted frequency bands likewise arises, because for instance specified frequencies have different usage restrictions, such as for example transmission performance, bandwidth, duty cycle etc. In wakeup mode an awakening of broadcast mode or bidirectional response mode is possible independently from each other.

In the following the invention will be explained more closely by means of an exemplary embodiment with reference to the drawings. In the process additional features and advantages of the invention arise.

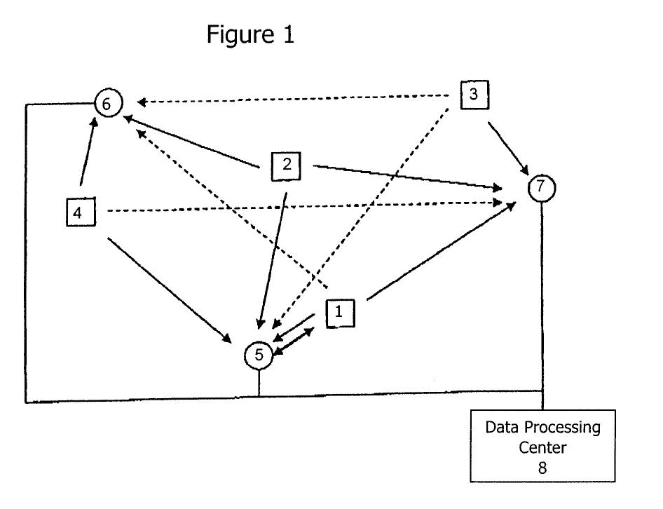

FIG. 1 shows as a schematic an application of RFID transponders in an application environment,

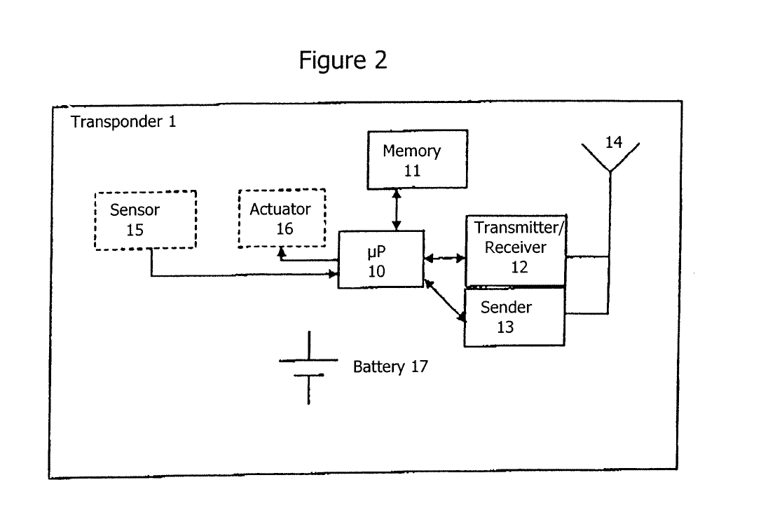

FIG. 2 shows as an example a block diagram of the structure of an inventive RFID transponder,

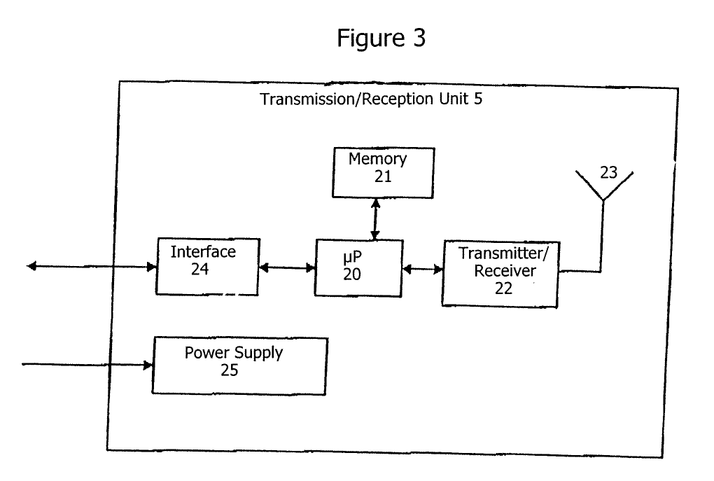

FIG. 3 shows as an example a block diagram of the structure of a transmission/reception unit for communication with the inventive RFID transponder.

FIG. 1 shows the application of inventive RFID transponders 1, 2, 3, 4 in an application environment. RFID transponders 1-4 can for example be used in inventory control, wherein an RFID transponder is unambiguously assigned to each object to be stored in a storage space. Each RFID transponder 1, 2, 3, 4 comprises an individual and non-alterable identification code by means of which it can be identified. The identification code makes unambiguous identification possible of the fact that each transponder is assigned to an object.

FIG. 2 shows the structure of such a transponder. The transponder, for instance transponder 1 in FIG. 1, comprises as its heart a microprocessor 10, which assumes control of all components of the transponder 1. The microprocessor is connected to a memory 11, which for example can exhibit a non-alterable read only memory as well as a rewritable memory area. For example, a non-alterable identification code is stored in the memory 11, as well as additional data which for example describe the object upon which transponder 1 is fastened. In addition inventive transponder 1 exhibits a transmitter 13, which is connected to an antenna 14. In addition a transmitter/receiver 12 is provided, which is likewise connected to antenna 14. Transmitter/receiver 12 as well as transmitter 13 communicate with microprocessor 10. A battery 17 for example serves as the power supply. Furthermore sensors 15 can be provided, which record environmental data and forward said environmental data to the processor 10 and which is buffered in the memory 11. Examples of possible sensors 15 are temperature sensors, optical sensors, acoustical sensors etc. Moreover actuators 16 can be provided which execute predefined actions from microprocessor 10. The actuators can for instance be illuminants, display devices, acoustical actuators or electrical or mechanical actuators.

RFID transponders 1-4 are for example arranged in distributed manner in a storage area and each assigned to an object. Said RFID transponders serve the purpose of identification of this product. For this purpose RFID transponders 1-4 are operated in broadcast mode, in which they permanently transmit a signal at predefined time intervals by way of the sender 13 and antenna 14, said signal for example containing the identification code which is stored in the memory 11. The transmitted identification code is received for instance by one or more higher level transmission/reception units 5, 6, 7 which are arranged in distributed manner in the storage area.

FIG. 3 shows the fundamental structure of a transmission/reception unit 5, 6, 7. By way of example transmission/reception unit 5 comprises a microprocessor 20 which communicates with a memory 21. Furthermore microprocessor 20 communicates with transmitter/receiver 22, which is connected to an antenna 23 and is able to send and receive data wirelessly via said antenna. Via an interface 24 the transmission/reception unit can communicate with and receive data for example from external units, for example a data processing center 8 or other transmission/reception units or transmit data to said external units. Interface 24 can for example be a wired or wireless interface. Transmission/reception unit 5 is supplied with power via a power supply 25.

RFID transponders 1 through 4 thus transmit signals of relatively short duration in broadcast mode. These signals are unidirectional and are frequently and randomly transmitted. In particular the identification code is transmitted cyclically, or measurement readings which are recorded by the sensor 15 or other status information, such as e.g. temperature, current position, motion information etc. Further in broadcast mode acyclical transmission of determined states related to the transponder or events is possible. Examples of events are motion, resting position, temperature above or below a specified temperature threshold, status changes of a switch, transponder passes a specified region (port). These events are preferably transmitted multiple times and at a higher repetition frequency in broadcast operation. Transmission via broadcast has a suitable anti-collision mechanism which prevents and reduces collisions with the transmission of other RFID transponders.

The broadcast transmissions of transponders 1-4 are received by higher level transmission/reception units 5, 6, 7. The solid arrows represent a broadcast transmission of RFID transponders 1 through 4 to transmission/reception units 5 through 7. Broadcast information transmitted by the RFID transponders is received by transmission/reception units 5 through 7. The dashed arrows represent broadcast transmission with too little range, i.e. broadcast data transmitted by RFID transponders 1 through 4 cannot be received by transmission/reception units 5 through 7 due to too great of a distance.

However, in accordance with the invention RFID transponders 1-4 do not only work in the above described broadcast mode, but rather simultaneously in bidirectional response mode, which is transacted via another frequency, such as broadcast mode, so that the two modes do not disturb each other.

Response mode permits bidirectional communication between RFID transponders 1-4 and higher level transmission/reception units 5-7. In this connection data can be transmitted with variable duration and variable information content. For example the data processing center 8 initiates a query of the data of the transponder 1 stored in memory. In this connection for example a corresponding command can be sent wirelessly to RFID transponder 1 from transmission/reception unit 5, said RFID transponder initiating a readout of static and dynamic data from the memory 11 of transponder 1. The transponder receives the command via antenna 14 and transmitter/receiver 12 and forwards said command to microprocessor 1 for evaluation. Processor 10 reads out the requested data from the memory 11. These data are then transferred to transmission/reception unit 5 via transmitter/receiver 12 and antenna 14, said transmission/reception unit receiving the data via antenna 23 and transmitter/receiver 22, forwarding the data to microprocessor 20, if applicable saving said data in the memory 21 and then forwarding it via interface 24 to data processing center 8.

In FIG. 1 the line with the double arrow shows bidirectional communication in response mode between RFID transponder 1 and transmission/reception unit 5. Data processing center 8 selects the “best” of transmission/reception units 5 through 7 for bidirectional communication with the relevant RFID transponder 1. The selection takes place on the basis of the signal quality, for example greatest field intensity, best signal to noise ratio by means of the broadcast information received by the RFID transponder.

In response mode in addition write operations can take place from transmission/reception units 5 through 7 to the memory areas 11 of transponders 1 through 4. Memory areas can be changed, deleted or otherwise modified. Furthermore in response mode a configuration of RFID transponders 1-4 can take place, e.g. with relation to parameters of broadcast mode, such as ping rate, alarm thresholds, programming of the sensors and actuators etc. In response mode it is also possible to directly control the actuators and sensors of transponders 1-4.

Finally so-called wakeup mode can be provided which is basically a part of response mode. In wakeup mode respective RFID transponders 1 through 4 can be awakened or put in an idle state. This wakeup puts the respective RFID transponder into a state in which it is then ready for bidirectional data communication. With a wakeup call for example a time for the beginning of bidirectional communication can be communicated. Further parameters for bidirectional communication such as bit rate, wakeup duration etc. can be communicated. Through the wakeup command in addition the broadcast mode of the RFID transponder can be switched on or off.

### LIST OF REFERENCE SYMBOLS

1 Transponder

2 Transponder

3 Transponder

4 Transponder

5 Transmission/reception unit

6 Transmission/reception unit

7 Transmission/reception unit

8 Data processing center

10 Processor

11 Memory

12 Transmitter/receiver

13 Transmitter

14 Antenna

15 Sensor

16 Actuator

17 Battery

20 Processor

21 Memory

22 Transmitter/receiver

23 Antenna

24 Interface

25 Power supply

1. A method for the operation of an RFID transponder, characterized in that the RFID transponder is operated either in broadcast mode or in bidirectional response mode or simultaneously in both aforementioned modes.

2. The method in accordance with claim 1, characterized in that a wireless transmitter is used for operation in broadcast mode, said transmitter being operated at a first frequency, and that a transmission/reception unit is used for operation in bidirectional response mode, said transmission/reception unit being operated at a second frequency.

3. The method according to claim 1, characterized in that operation in broadcast mode is controlled by commands which are communicated during operation in response mode by a higher transmission/reception unit (5).

4. The method according to claim 1, characterized in that the RFID transponder is operated in wakeup mode, wherein upon receipt of a wakeup command from a higher level transmission/reception unit broadcast mode, response mode or both modes are activated.

5. An RFID transponder with a processor, a data storage and a wireless transmitter, characterized in that a wireless transmission/reception unit is provided which can be operated independently from the transmitter.

6. The RFID transponder according to claim 5, characterized in that a common antenna is present for the wireless transmitter and the wireless transmission/reception unit.

7. The RFID transponder according to claim 5, characterized in that said RFID transponder comprises a sensor as an interface.

8. The RFID transponder according to claim 5, characterized in that said RFID transponder comprises an actuator as an interface.

9. The method according to claim 2, characterized in that operation in broadcast mode is controlled by commands which are communicated during operation in response mode by a higher transmission/reception unit.

10. The method according to claim 2, characterized in that the RFID transponder is operated in wakeup mode, wherein upon receipt of a wakeup command from a higher level transmission/reception unit broadcast mode, response mode or both modes are activated.

11. The method according to claim 3, characterized in that the RFID transponder is operated in wakeup mode, wherein upon receipt of a wakeup command from a higher level transmission/reception unit broadcast mode, response mode or both modes are activated.

12. The RFID transponder according to claim 6, characterized in that said RFID transponder comprises a sensor as an interface.

13. The RFID transponder according to claim 6, characterized in that said RFID transponder comprises an actuator as an interface.
